(19) United States
(12) Patent Application Publication
(10) Pub. No.: US 2019/0156370 A1
(43) Pub. Date: May 23, 2019

(54) SYSTEM AND METHOD FOR TARGETED ADVERTISING USING GEOFENCING

(71) Applicant: SIMPLIFI HOLDINGS, INC., Fort Worth, TX (US)

(72) Inventors: PAUL RANDAL HARRISON, KELLER, TX (US); FROST RENE RAVENEL PRIOLEAU, FORT WORTH, TX (US)

(73) Assignee: SIMPLIFI HOLDINGS, INC., Fort Worth, TX (US)

(21) Appl. No.: 16/314,439

(22) PCT Filed: Jul. 5, 2017
(86) PCT No.: PCT/US17/40691

§ 371 Date: Dec. 30, 2018

Related U.S. Application Data
(60) Provisional application No. 62/358,512, filed on Jul. 5, 2016.

(51) Int. Cl. G06Q 30/02

(52) U.S. Cl. CPC G06Q 30/0267; G06Q 30/0275

(57) ABSTRACT

A message targeting system enables content providers to define geophysical zones for which entering mobile electronic devices may receive messages. The targeting system catalogs messaging campaigns for client defined zones and stores them in a database. An exchange identifies mobile devices for targeting and auctions available display space thereon, providing the targeting system with geolocation and other device-specific data. The targeting system contrasts device geolocation data to client created zones to identify qualifying campaigns, selects one and issues its bid. If the targeting system wins the bid, the exchange transmits its contact information to the mobile device to enable it to contact the targeting system. If the device does so, the targeting system transmits the message to the device directly, even if the device has left the zone. The targeting system logs device data and tracks subsequent

### BACKGROUND OF THE INVENTION

### 1. Field of the Invention

The present invention relates generally to message targeting to specific recipients, and particularly to messages related to advertising. More particularly, the present invention relates to advertising relevant to specific customers based upon selectable, identifiable customer traits. Still more particularly, this invention relates to a system and method of identifying such traits through network geolocation data from customers' mobile electronic devices, and matching such geolocation data to advertising campaigns by marketing clients. Even more particularly, this invention relates to means by which marketing clients may associate advertising campaigns with geographic areas, which in turn are matched to customers based on the geolocation of their electronic devices.

### 2. Description of Related Art

Message distribution generally, and mass marketing campaigns particularly, rely upon individual responses to published messages and soliciting responses through conventional communication means or physical attendance at advertised locations. Mass marketing in particular strives for ways to make such campaigns more commercially successful, and one means for doing so is to target advertising campaigns to customers whose interest therein may be inferred from traits of said customers.

One such trait is the location of mobile customers, the classic targeting means being billboards located strategically to get the attention of passers by. Common clients of billboard advertising systems are nearby local merchants and/or service providers who wish to attract the attention of their neighbors through such billboards, customer traits being inferred from the fact that they travel on certain streets and highways. Other legacy systems include radio station broadcasts targeting service areas with entertainment to lure listeners into hearing audio advertising by local merchants, and another is mail and hand delivery of flyers or questionnaires to residences based on demographic data about neighborhoods.

Such means are blunt instruments at best for identifying customer purchasing traits, however, as illustrated by common response rates of fractions of one percent. Advertisers thus perennially seek to narrow the focus of their advertising dollars so that their message is relevant to a larger percentage of the customers to whom it's rendered. A recent strategy involves capturing geographic location (hereinafter “geolocation”) data from customers' mobile electronic devices (largely cellular telephones; hereinafter “mobile device(s)” or “device(s)”) and targeting advertising messages (hereinafter “ad(s)” or “messages”) to them based on inferences about them from their geolocation data. Not only can device geolocation data be refined to target much smaller groups and geographic areas than can billboards and radio broadcasts, but databases containing historical information about specific devices may be accumulated, lending increasingly more precise information about their owners' consuming traits.

Privacy laws, however, limit how precisely a device owner (hereinafter “user”) can be profiled. One means of overcoming such a limit is to get users voluntarily to provide such information by offering special deals if they agree to have an application (hereinafter “app”) installed onto their device which can be targeted periodically by advertisers. Through a wireless network, such as a telephone cellular network, the app transmits geolocation data to the advertiser who matches such geolocation data to ad campaigns of its clients and pushes appropriate client campaign content directly to the user's device to be displayed by the app.

Selecting among client advertising campaigns to target to such apps, however, heretofore has been imprecise, usually targeting any mobile devices which wander into a region defined by a radial distance from a given address, or even of a telephone cell tower. Such imprecision can result in many messages targeted to mobile devices the owners of which have no interest in the advertiser's offerings. A need exists for means for more precisely selecting advertising campaigns that take into account specific traits of potentially targeted mobile devices users.

One possible solution to the geographic precision problem is described in U.S. Pat. No. 8,903,426 to Tholkes, et al. Tholkes describes a system whereby ad clients create “geofences” by registering vertices on a map, the system then imposing lines between the vertices to create a polygon intended to represent a geographic area. The client then may associate ad content with the geographic area. Tholkes' system manages the entire communication process, receiving availability and geolocation data from an app residing on mobile devices, prioritizing overlapping geographic areas created by a client and pushing ad content associated with the highest priority geographic area to the app, the ad content displayed on the device by the app. Though Tholkes' geofencing method improves upon the geolocation precision problem, it still relies for functionality upon the app residing on each target device, which app maintains a standing relationship with Tholkes' system and communicates geolocation data directly to said ad publisher. Such a requirement of an app working directly with an ad publisher significantly limits the effectiveness of Tholkes' system. A need exists for a system and method that can target users entering a client-specified zone without requiring an advertiser's app resident on said user's device.

### SUMMARY OF THE INVENTION

A message targeting system enables content providers to define geophysical zones for which entering mobile electronic devices may receive messages. The targeting system catalogs messaging campaigns for client defined zones and stores them in a database. An exchange identifies mobile devices for targeting and auctions available display space thereon, providing the targeting system with geolocation and other device-specific data. The targeting system contrasts device geolocation data to client created zones to identify qualifying campaigns, selects one and issues its bid. If the targeting system wins the bid, the exchange transmits its contact information to the mobile device to enable it to contact the targeting system. If the device does so, the targeting system transmits the message to the device directly, even if the device has left the zone. The targeting system logs device data and tracks subsequent encounters with the device for refining future selection criteria.

### BRIEF DESCRIPTION OF THE DRAWINGS

The novel features believed characteristic of the present invention may be set forth in appended claims. The invention itself, as well as a preferred mode of use and further objects and advantages thereof, will best be understood by reference to the following detailed description of an illustrative embodiment when read in conjunction with the accompanying drawings, wherein:

FIG. 1 shows a schematic of the advertising targeting system and method of the present invention, including pathways by which an advertising unit is published to a mobile device.

FIG. 2 shows a schematic of the targeting system resources for selecting an advertising message to be delivered to a mobile device and for storing mobile device data for future usage.

FIG. 3 shows the exchange bidding process for marketing ad space on the mobile device.

FIG. 4 shows the steps in the process the targeting system of the present invention follows to select a campaign for bidding.

FIG. 5 shows the steps in the process the targeting system provides to clients for establishing selection criteria among potential targets for their ad content.

FIG. 6 shows in top plan view a regional map image seen by the targeting system client, and shows points selected by the client to specify a geographically delimited target advertising area.

FIG. 7 shows in perspective view a grid overlay of the regional map shown in FIG. 6 whereby a targeting system client's designation of points on the regional creates a polygon upon the grid, which polygon represents the delimited geographic area within which the client wishes to target advertising.

### DESCRIPTION OF A PREFERRED EMBODIMENT

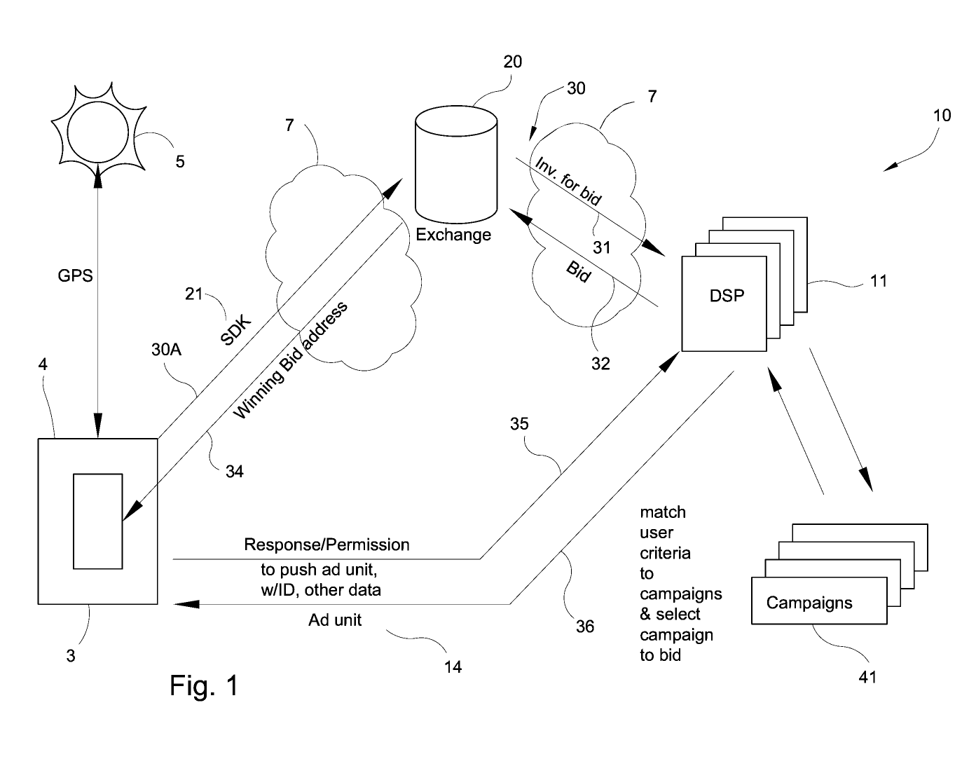

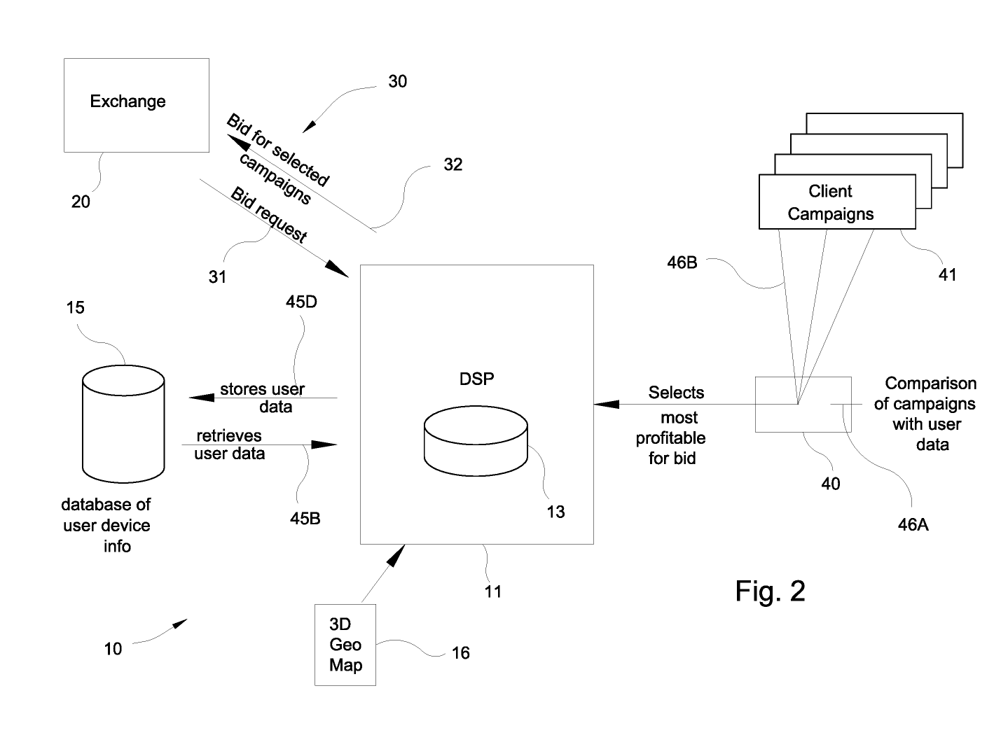

Referring now to the figures, and particularly to FIGS. 1-2, a particular embodiment of the present invention comprises advertising targeting system 10 embodying apparatus and steps by which message unit 14 is selected for display on browser 4 of mobile electronic device 3. Targeting system 10 functions as a message manager and runs on server 13 of Demand Side Platform (“DSP”) 11, preferably coupled to a global computer network (hereinafter “the Internet”). Independent exchanges 20, also preferably coupled to the Internet, function as channel servers which identify and convey mobile device 3 geolocation data to DSP's 11. In the advertising context, exchanges 20 arrange for advertising space to be made available on device 3, as discussed below, and then auction said ad space to DSP's 11, the winning bid buying DSP 11's advertising client the right to publish message (ad) unit 14 to device 3.

One having ordinary skill in the art will recognize that any type of global, wide area, local area, radio or telephone network, could serve the purpose of the Internet without departing from the spirit and scope of the present invention. One having ordinary skill in the art also will recognize that, though the present invention is described hereinafter in the context of an advertisement targeting system, it could serve to render more relevant messages and information in divergent contexts, such as news alerts, emergency warnings and triggering event announcements, where targeting specific mobile devices 3 because of their behavior or geolocation traits is an effective and efficient strategy. One having ordinary skill in the art thus will recognize that all such purposes and applications, with concomitant variations in the particular embodiment, are considered to be within the spirit and scope of the invention.

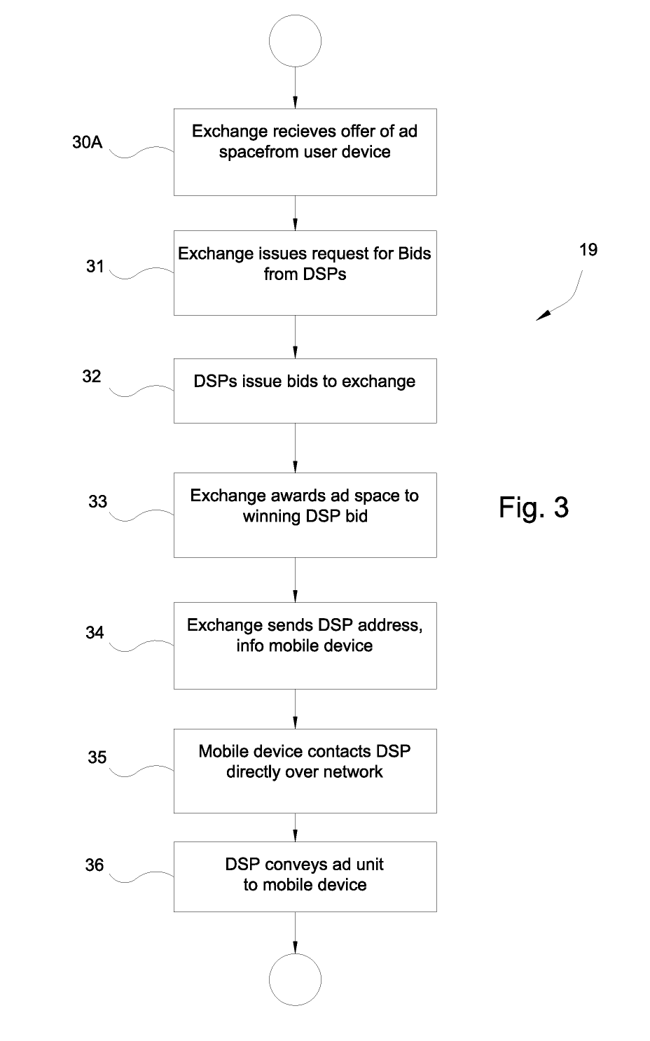

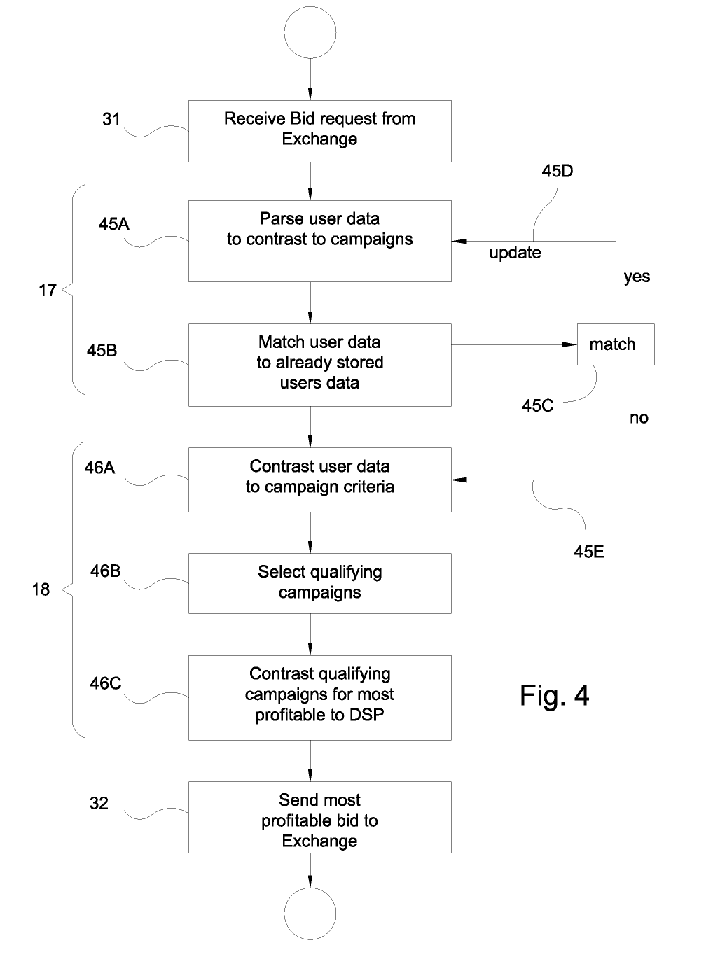

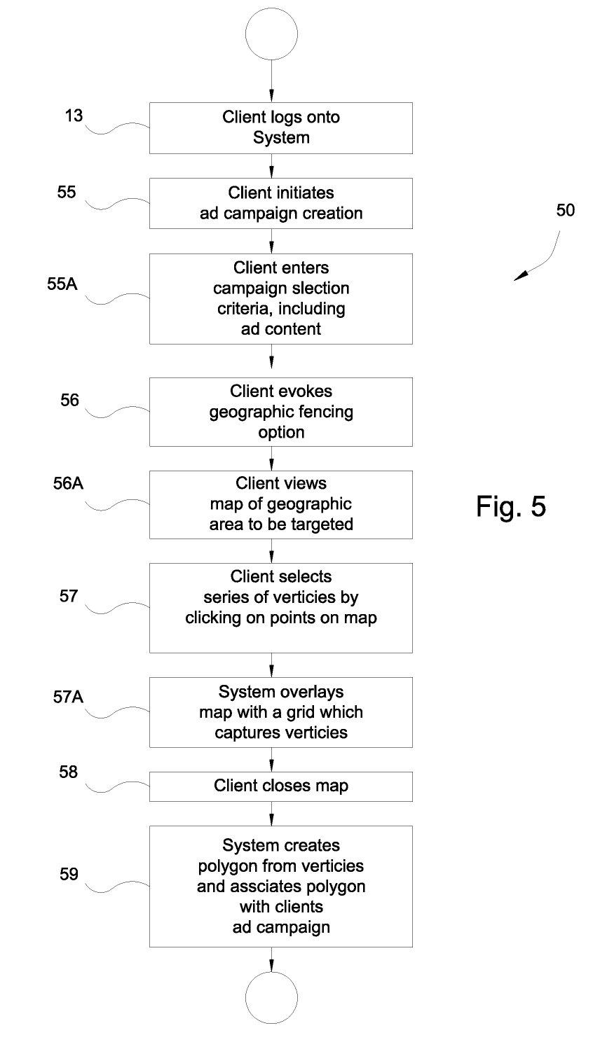

Using targeting system 10, DSP 11's advertising clients create campaigns 41 to compete for device 3 ad space. The clients provide ad units 14 and specify a geographically targeted area, duration and time of day and week of campaign 41, and a maximum price they'll pay for a winning bid. Targeting system 10 uses software routines to manage the clients' campaigns 41 and to select one campaign 41 for use for placing bids in response to RFB's from exchanges 20. Targeting system 10's software routines include geofencing routine 50 (see FIGS. 5-7, discussed in more detail below) by which advertisers initiate campaigns 41 and focus their ad content 14 toward geographically delimited zones 65; user device 3 database management, or cataloging, routine 17 (FIG. 4, also discussed in detail below) which accumulates and updates data about devices 3; campaign selection routine 18 (FIGS. 1-2, 4) which associates such client zones 65 with ad content 14 and bid data; and ad publishing routine 19 (FIGS. 3-4) for bidding on ad opportunities and publishing ad content 14 to mobile electronic devices 3.

### User Device Ad Space Applications

Exchange 20 provides software developers (not shown) with kits (SDK's) by which they can create modules to promote advertising within available space on browser 4 running on device 3. SDK generated and installed device modules (hereinafter,“SDK modules”) then convey user device 3 identification (ID) data to exchange 20 for participation in an auction of said available advertising space. Presumably, and typically in the advertising context, the software developers or their customers (e.g. browser or application publishers) receive economic incentive from exchange 20 for accepting each message pushed to the SDK modules.

SDK modules commonly run on conventional device 3 browsers 4 such as Apple's OSx Safari for iPhones and iPads, Google Chrome for Android devices, or Windows Mobile for devices which employ Windows based systems. Such SDK modules usually run continuously in background mode within browser 4, and may or may not be controllable by the user (not shown) of device 3. Other SDK modules may reside solely on web sites onto which user device 3 may land while browsing the internet, and have ad space to market only while the user device 3 remains on the web site. Still further, an SDK module may be part of another software app installed onto device 3 by the user, such as an app designed for a specific purpose or function (e.g. to detect and identify environmental music, to access and display weather data, to create documents, or the like) independent from but running in browser 4 or device 3's operating system.

A special form of SDK module harvests not only user ID information, but also geolocation data for device 3 in real time, conveying such geolocation data along with other user ID data to exchange 20 for distribution in conjunction with exchange 20's Request for Bids, discussed below. Alternately, exchange 20 may infer or estimate device 3's geolocation from statistical models owned and operated by exchange 20 or others. In the latter case, specific latitude and longitude of the geolocation of device 3 is derived from set locations such as the city center (not shown) most closely associated with device 3, or even postal service (e.g. billing address zip code) data about device 3. Obviously, actual geolocation data, derived from device 3's geo-awareness using the Global Positioning System (GPS), or a wireless network (“wifi”) internet protocol (IP) address, is preferable, as the geolocation range can be narrowed considerably, thereby permitting inferences about preferences and travel practices of the user of device 3. Though agreements within the National Advertising Initiative limit the precision with which user device 3 geolocation data can be utilized, it still can be within 100 meters of the actual location of device 3, a considerable improvement on city center or postal service data.

### Ad Space Auctions

Exchange 20 receives user ID data, including if available, geolocation data of device 3 and selects a number of DSP's 11 to which to issue a Request for Bids (RFB) to win the proffered ad space on device 3. DSP 11's comprise server systems running software which can, within 100 milliseconds or less, receive RFB's, market them to their client base, receive advertising content, in the form of ad units 14, from one or more advertising clients, select among such ad content according to DSP 11 criteria, issue a bid to exchange 20, and, if DSP 11's bid is successful, publish the client's ad unit 14 to device 3. The system requires no DSP 11 to install an app on device 3. DSP 11 communicates directly with device 3 only to receive an invitation for ad unit 14 and to publish ad unit 14 to device 3. Other than the foregoing, DSP 11 has no relationship with device 3 and, by implication, its user owner.

Referring now also to FIGS. 3-4, exchange 20 conducts an auction 30 of the ad space conveyed to it by the SDK module. It receives 30A the relevant data from the SDK module, such as device 3 identifier, geolocation (typically physical latitude and longitude), type of device 3, type of app running on device 3, and any minimum bid required by the SDK module. Exchange 20 then issues 31 its RFB to selected DSP 11's which it determines qualify for the bid. DSP 11's review the bid criteria and, if they have an interest in the RFB, issue 32 their bids for the ad space. After the time for receiving bids (commonly on the order of 100 milliseconds), exchange 20 awards 33 the ad space to the winning DSP 11 and sends 34 DSP 11's contact information to the SDK module.

Depending upon the SDK module, the IP address of device 3 may be sent to DSP 11 automatically, or the SDK module may wait for the user of device 3 to evoke the communication, for example by clicking on a link (not shown). In either case, mobile device 3 transmits 35 its IP address directly to DSP 11, with other identifying information to associate the message with the RFB which DSP 11 won in exchange 20's auction 30. DSP 11 then conveys 36 ad unit 14 to device 3 directly for display by the SDK module on device 3 according to its own display criteria. DSP 11 does not control how or when the SDK module displays ad unit 14 except for endemic formatting which might be embedded within ad unit 14. Ad unit 14 is not sent through exchange 20, but directly through the wireless network to which device 3 is connected.

### Bid Processing

As best seen in FIG. 4, targeting system 10 processes the RFB by using its campaign selection routine 18 to contrast 46A device 3's geolocation and other data with selection criteria within its currently active ad campaign database 41, selecting any campaigns 41 which qualify for the RFB. Qualification of campaigns 41 may result from matching selection data such as geolocation, recency, known user preferences or the like. Targeting system 10's campaign selection routine 18 then proceeds to select 46B one of the qualifying campaigns 41, based primarily upon the greatest profit to be made by DSP 11 if ad unit 14 is published to device 3.

For example, one client may offer one cent (US$ 0.01) for a publication of its ad unit 14, whereas another client may offer five cents (US$ 0.05). Targeting system 10 of course may use other criteria, such as preference of one client over another for non-economic reasons, but primarily its campaign management routine will select the campaign which yields DSP 11 the most profit. Once having selected 46C which campaign 41 to proffer to exchange 20, targeting system 10 calculates the maximum bid it can offer in response to the RFB and selects that amount or a fraction thereof to convey to exchange 20. It then proceeds with issuing 32 a bid to exchange 20, as discussed above.

### User Device Database

As best seen in FIGS. 2 and 4, a particular feature of advertising targeting system 10 comprises its user database 15 which stores data from DSP 11's previous encounters, if any, with device 3. For example, if device 3 previously appeared in a RFB from any exchange 20, targeting system 10's user catalog routine 17 (see FIGS. 2, 4) creates a record of such encounter and stores it in database 15 for future reference. The record includes user and device 3 identification data, such as device 3's unique AAID/IDFA identifier, device 3's geolocation data, if any, available to DSP 11 during the encounter, recency data of the encounter, whether or not an ad unit 14 was published to device 3 and whether or not the user of device 3 acted upon ad unit 14.

In operation, targeting system 10 running on DSP 11's server 13 receives 31 a RFB from exchange 20. Targeting system 10's user catalog routine 17 then parses 45A the user data and contrasts 45B device 3's ID to records in user database 15 to look for matches 45C. If a match is found, data from the current encounter with device 3 is used to update 45D user database 15 prior to acting upon the RFB. If no match is found 45E, targeting system 10's user catalog routine creates a new record for device 3 in database 15.

### Geofencing

Referring now also to FIGS. 5-7, another particular feature of the present invention comprises the manner in which clients may specify geographic criteria for their ad content. Targeting system 10 provides clients access to its geofencing routine 50 (FIGS. 5-7) residing on system 10's server 13 which calls a third-party 16 (FIG. 1) geolocation map 60, showing a geographic area in which the client may wish to advertise. For example, a store located on a given street corner or in a shopping mall may wish to target pedestrians walking in the vicinity or in the mall and its parking lots, or perhaps those devices 3 entering the vicinity of their competitors. Thus, granular geographic zone 65 definitions can be significantly important.

Map 60 displays geographic features such as roadways, landmarks, buildings and the like which allow the client to recognize the area and to select delimitations for advertising zones 65. Clients may zoom in and out (not shown) on map 60, desired to focus on greater or smaller geographic areas, and to see more detail, such as specific street intersections. A suitable map 60 is Google Maps available from Google, Inc., of Mountain View, Calif. USA. Such map 60 may be purchased or licensed and displayed by targeting system 10 to clients as they specify the general region in which they wish to advertise to mobile devices 3.

Using targeting system 10's campaign creation option, a client opens geofencing routine 50 and views map 60. The client selects a specified geographic region for campaign 41, and creates vertices A-E by clicking on points the client selects on map 60. The client may select 57 three or more vertices on map 60 corresponding with specific locations, such as street corners in a city or road intersections in the countryside. As each vertex A-E is selected, system 10's geofencing routine 50 draws a line from the previously selected vertex. The lines between vertices A-E may or may not be straight, as defined by system 10's geofencing routine 50. As the client proceeds in an orderly fashion from first vertex A to the next B-E in sequence, a circumscribed geographic zone 65 appears on map 60. Once the client believes the circumscribed zone surrounds a geographic area into which the client is interested in sending ad units 14, the client closes 58 system 10's geofencing routine by clicking again on the first vertex A selected. The client can adjust the shape of the zone by moving vertices or creating new vertices by clicking on a point on a line between two adjacent vertices (neither shown).

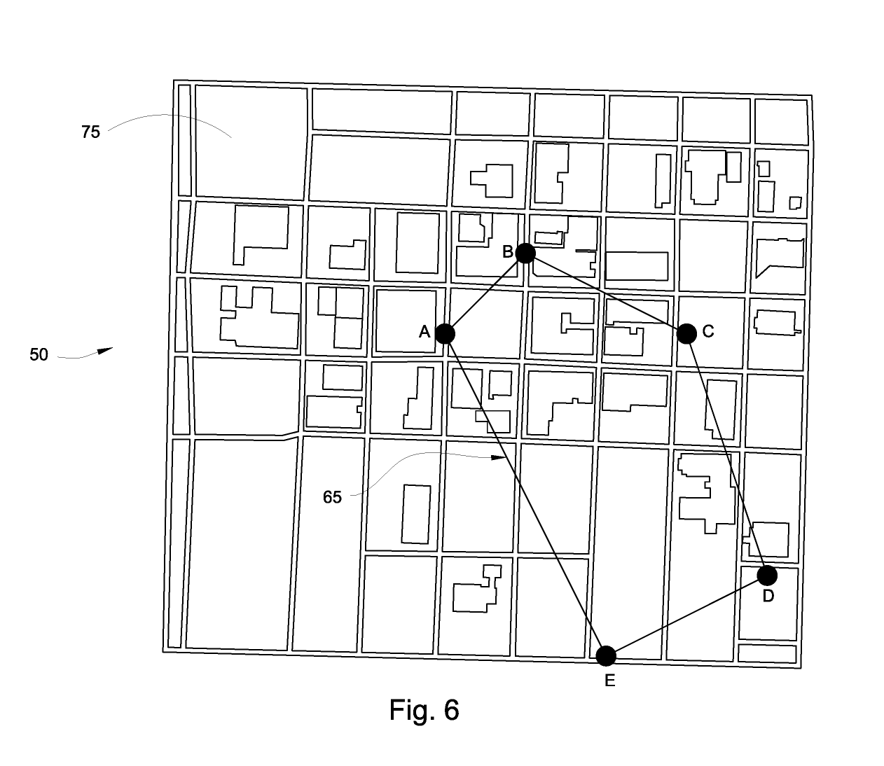

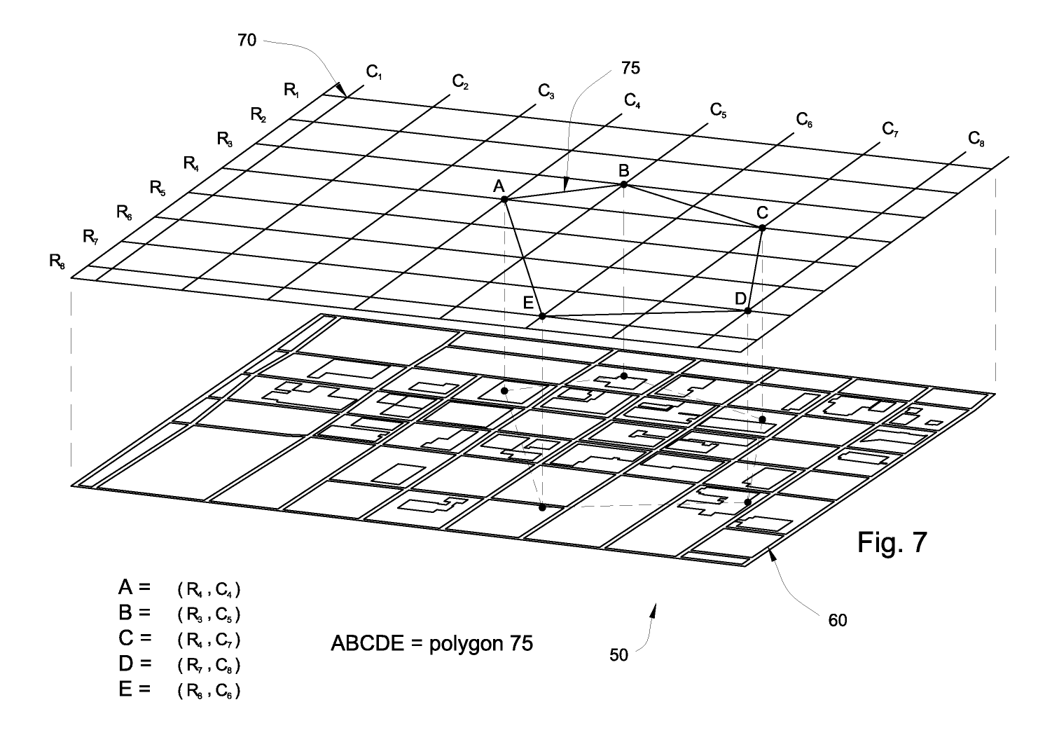

As best seen in FIG. 7, however, the clients actually are not working on map 60 at all. Instead, system 10's geofencing routine 50 overlays 57A grid 70, having a plurality of rows R₀, R₁, R₃, R₄, . . . R_{∞} and columns C₀, C₁, C₃, C₄, . . . C_{∞} as needed to completely encompass map 60 as it is seen by the client (FIG. 6). A client then views 56A map 60 but does not see grid 70. If the client zooms in and out (not shown) on map 60, grid 70 scales accordingly so that points on grid 70 match points on map 60 at any level of detail.

When the client signifies 58 completion of region 65 to system 10's geofencing routine 50, it then creates 59 polygon 75 representing a region of GPS latitude and longitude into which the client's ad campaign 41 will be directed. System 10's geofencing routine 50 then associates 59 polygon 75 with the client's ad campaign 41 so that campaign selection routine 18 described below may employ it as one of the criteria for selecting qualifying campaigns 41 for use in responding to RFB's.

### Campaign Selection

When DSP 11 receives a RFB from exchange 20, targeting system 10's campaign selection routine 18 contrasts 46A the latitude and longitude data from device 3's geolocation data with polygon 75 and calculates whether or not device 3 entered any client's selected zones 65. If so, a list of qualifying campaigns 41 is compiled 46B for consideration as a response to exchange 20's RFB. System 10's campaign selection routine 18 then contrasts 46C other campaign data, such as offering price, to select one campaign among all that qualify as a basis of responding 32 to the RFB, as discussed in more detail above. If the response 32 to the RFB wins the bid from exchange 20, system 10's ad publishing routine 19 (FIG. 3) publishes campaign 41 ad unit 14 immediately to device 3, or at a later time, even if device 3 has left campaign 41's geographic area 65.

### SUMMARY

Thus, by providing its clients means for precise specification of geographic areas, using targeting system's geofencing routine 50, targeting system 10 allows them to develop campaigns 41 with flexibility to target mobile devices 3 with geographic precision. By tracking mobile devices 3 in its user device database 15, targeting system 50 offers DSP 11's clients more and richer information about device 3 users than simply knowing they've been in a specific area at least once. Thus, DSP 11's clients may stratify campaigns 41 by user device 3 familiarity, such as frequency of attendance in a geographic area, responses to previous campaigns 41, other geographic areas in which the user devices 3 have been found, and the like. Thus, for a given geographic area, a client may post several campaigns 41 with different prices they're willing to pay for pushing ads to devices 3 with different user behavior patterns. Further, as targeting system 10 contrasts one campaign 41 from another, it may be able to increase its own profit by selecting campaigns 41 which rely upon richer knowledge about user devices 3.

While the invention has been particularly shown and described with reference to preferred and alternate embodiments, it will be understood by those skilled in the art that various changes in form and detail may be made therein without departing from the spirit and scope of the invention. For example, polygon 75 has been described above as associated with points on map 60, and thereby substantially cartographic in nature. However, vertices A-E could just as well be locations on different floors of a tall building or apartment complex. Polygon 75 accordingly could be confined entirely to such building, without requiring map 60 at all. In other words, the invention described herein is not confined to a cartographic plane represented by a map, but is three-dimensional in nature, and could be entirely vertical, horizontal or a combination of the two.

An example of how this might be useful is illustrated by the Unite d'Habitation, Boulevard Michelet, 13008, Marseille, France, wherein the famous architect, Le Corbusier, designed and built in 1952 an entire city located within a single building. The building houses over 1600 residents divided among eighteen floors. It contains residential units, schools, shops, restaurants, medical facilities, a hotel, a library, and a rooftop garden with a running track, gym and pool. Residents can shop, play, attend school and come together without leaving their high rise “vertical garden city.” Advertisers for one or another of the shops or restaurants within the building, or others outside of the building, may wish to target certain residents, and/or their visitors, to the exclusion of others, e.g. those on only one floor or another (e.g. floors may or may not have children, or the different residential units could be occupied by persons of significantly divergent economic status).

In the non-advertising context, exchanges 20 may not be for-profit entities, but instead may be agencies or contractors charged with, e.g., warning about terrorist emergencies at a university (targeting students, parents and teachers wherever they may currently be), or expected or actual severe weather emergencies (e.g. tornados), warning absent residents to stay away and those in the vicinity to take cover immediately. In such cases, DSP's 11 may be a single entity, such as government law enforcement or weather monitoring agency.

1. A message targeting system for targeting message content toward specific target recipients identified by their mobile electronic devices, the message targeting system comprising
a channel server coupled to a network;
at least one mobile electronic device in electronic communication with said channel server, each one of said at least one mobile electronic device having a device location;
a message manager coupled to said network and in electronic communication with said channel server, said message manager having
a message database of message manager client messages;
means for accepting a client message from at least one message manager client, said client message adapted to be stored in said database of message manager client messages and to be targeted to one or more of said at least one mobile electronic device;
means for selecting one of said client messages from said message database to be published to one of said at least one mobile electronic device; and
means for publishing said client message to said at least one mobile electronic mobile device.

2. The message targeting system of claim 1 wherein
each client message within said message database includes
a client message content;
a client message start time, a message end time, and a message duration;
a client message maximum price; and
a geographic area into which said message targeting system is to publish said client message content to said select one of said at least one mobile electronic device.

3. The message targeting system of claim 2 and further comprising
a geofencing routine adapted to
display a map to said client, said map representing a geographic region;
enable said client to specify a geographic subregion on said map by selecting at least three vertices of a map polygon circumscribing said geographic subregion on said map, said geographic subregion defining said delimited geographic area; and
means for capturing said map polygon and associating it with said client message in said message database for comparison to geolocation data from said at least one mobile electronic device.

4. (canceled)

5. The message targeting system of claim 3 wherein said means for capturing said map polygon comprises
a grid adapted to overlay onto said map, said grid having rows and columns defining latitude and longitude coordinates on said map;
a grid polygon within said grid, said grid polygon being congruent with said map polygon and having with a vertex corresponding to each vertex of said at least three vertices of said map polygon, said grid polygon thereby assigning latitude and longitude coordinates to each of said at least three vertices, said grid polygon adapted to be contrasted said device location of said at least one mobile electronic device.

6-7. (canceled)

8. The message targeting system of claim 2 wherein said means for selecting one of said client messages comprises
a message qualifying software routine adapted to compare said device location to said geographic area for each message and to select a plurality of qualified client messages in which said device location is within said geographic area;
a selection software routine adapted to compare said maximum message price of each of said qualified client messages to identify one of said plurality of qualified client messages for which said maximum message price is highest.

9. The message targeting system of claim 1 wherein
each message in said message database includes
a polygon associated with each of said messages, said polygon defining a plurality of target latitude and longitude coordinates within which said message targeting system may publish said message to said at least one mobile electronic device.

10. The message targeting system of claim 9 wherein said polygon comprises
at least three polygon vertices disposed on a map;
a line segment connecting each adjacent two of said at least three polygon vertices; and
a grid overlay disposed atop said map, said grid adapted to convert said polygon vertices into latitude and longitude coordinates.

11. The message targeting system of claim 10 wherein
said at least three polygon vertices are established by
presenting said client with a view of said map;
enabling said client to select points on said map to establish said at least three polygon vertices;
displaying onto said map said line segments connecting said at least three polygon vertices to enable said client to see a delimited geographic region defined by said vertices; and
mirroring said at least three polygon vertices onto said overlay to determine said latitude and longitude coordinates of each of said vertices.

12. The message targeting system of claim 1 wherein said means for publishing comprises
a software routine adapted to receive a request for bids from said channel server, said request for bids including said device location;
a software routine adapted to convey said device location to said means for selecting one of said client messages and to receive a select one of said client messages;
a software routine adapted to issue a bid in response to said request for bids based on said select one of said client messages;
a software routine adapted to receive a communication from said mobile electronic device inviting said select one of said client messages; and
a software routine adapted to publish said select one of said client messages to said mobile electronic device.

13. The message targeting system of claim 1 and further comprising
a mobile device database having a record of at least one encounter with each of said at least one mobile electronic device, said record including for each of said at least one encounter
a date and time of said at least one encounter;
a device location associated with said at least one encounter;
a notation indicating if bid was issued to said channel server for said at least one encounter with said at least one mobile electronic device;
a notation indicating if a client message was published to said at least one mobile electronic device during said at least one encounter;
a notation indicating if said mobile electronic device responded to said client message during said at least one encounter; and
a device database update software routine for updating said mobile device database with a record of additional ones of said at least one encounter with each of said at least one mobile electronic device.

14. The message targeting system of claim 13 and further comprising
a device analysis software routine adapted to develop assessments of recency and frequency of encounters with said at least one mobile electronic device, and to develop assessments of success of any client messages published to said at least one mobile device, said success being defined by whether or not said at least one mobile electronic device responded to said select client message, said device analysis software routine further adapted to provide its assessments to said means for selecting one of said client messages for publication to said at least one mobile electronic device.

15. A message manager coupled to a network and adapted to target message content toward specific target recipients, said target recipients having a mobile electronic device having a device location defined by a device latitude and a device longitude, said mobile electronic device being in electronic communication with a channel server, said channel server coupled to said network, the message manager comprising
a message database of message manager client messages, each of said client messages including a message content, a message price and a message geographic area into which said message manager may publish said message content to said target recipients;
a geofencing software routine adapted define said message geographic target area, said geofencing software routine having
a map adapted to be displayed to said client, said map representing a geographic region;
a geographic target area software routine adapted to enable said client to select at least three vertices of a map polygon circumscribing said geographic target area on said map; and
a grid adapted to overlay onto said map, said grid having rows and columns defining latitude and longitude coordinates on said map, said grid adapted to intercept and to assign latitude and longitude coordinates to said at least three vertices, said latitude and longitude coordinates defining a polygon;
a bid receiving software routine adapted to receive bids from said channel server for publishing a select one of said client messages to said mobile electronic device;
a message selection software routine adapted to contrast said device latitude and said device longitude to said polygon and to compile a group of client messages for which said device location falls within said message geographic target area; and
a price comparison software routine adapted to compare said message price of all of said client messages within said group of client messages and to identify a select one said client messages from said group of client messages for publishing to said mobile electronic device.

16. The message manager of claim 15 and further comprising
a bidding software routine adapted to
issue a bid in response to said request for bids based on said select one of said client messages; and
receiving a communication from said mobile electronic device inviting said select one of said client messages; and
a message publishing software routine for publishing said select one of said client messages directly to said mobile electronic device.

17-19. (canceled)

20. An improved method of targeting message content toward specific target recipients, said target recipients having a mobile electronic device having a device location, said mobile electronic device being in electronic communication with a channel server coupled to a network, the improved method comprising
providing a message manager coupled to said network and in electronic communication with said channel server, said message manager having
a message database of message manager client messages;
means for accepting a message from at least one message manager client, said message adapted to be stored in said database of message manager client messages and to be targeted to one or more of said at least one mobile electronic device;
means for selecting one of said client messages from said message database to be published to one of said at least one mobile electronic device; and
means for publishing said message to said at least one mobile electronic mobile device
providing a client preferred geographic location associated with each of said client messages;
providing a client specified price for publishing each of said client messages to said mobile electronic device; then
receiving a request for bids for an opportunity to publish one of said client messages to said mobile electronic device, including receiving said device location; then
selecting a preferred one of said client messages based on said device location and said highest specified price; then
bidding on said opportunity to publish based on said preferred one of said client messages; then
accepting an invitation to publish said preferred one of said client messages from said mobile electronic device; then
publishing said preferred one of said client messages to said mobile electronic device.

21. The improved method of claim 20 wherein the step of providing a client preferred geographic location includes the following steps
displaying to said client a map of a geographic region; then
enabling said client to select at least three vertices on said map; then
converting said at least three vertices to a polygon; and
assigning latitude and longitude coordinates to said polygon; then
associating said polygon with said message.

22. The improved method of claim 21 wherein the converting and assigning steps further include the steps of
overlaying said map with a grid, said grid having rows and columns defining latitude and longitude lines; then
intercepting said at least three vertices on said map as points on said grid; and
identifying said latitude and longitude coordinates for said polygon with said grid.

23. The improved method of claim 21 wherein the selecting step includes the additional steps of
contrasting said device location to said client preferred geographic location for each of said client messages; then
identifying a group of client messages in which said device location falls within said client preferred geographic location of each of said client messages within said group of client messages; then
comparing said client specified price among each of said client messages in said group of client messages then
electing said preferred one of said client messages.

24. The improved method of claim 20 wherein the message manager further comprises
a mobile device database having a record of at least one encounter with said mobile electronic device, said record including for each of said at least one encounter
a date and time of said at least one encounter
a device location associated with said at least one encounter;
a notation as to whether or not a bid was issued to said channel server for said at least one encounter with said at least one mobile electronic device;
a notation as to whether or not a select client message was published to said at least one mobile electronic device during said at least one encounter;
a notation as to whether or not said mobile electronic device responded to said select client message during said at least one encounter; and
a device database update software routine for updating said mobile device database with a record of additional encounters with said mobile electronic device.

25. The message targeting system of claim 24 wherein said message manager further comprises
a device analysis software routine adapted to develop assessments of recency and frequency of said encounters with said mobile electronic device, and to develop assessments of success of any client messages published to said mobile electronic device, said success being defined by whether or not said mobile electronic device responded to said select client message.

26. The message targeting system of claim 25 wherein said selecting step further includes the steps of
basing selection of said preferred one of said client messages upon said assessments provided by said device analysis software routine.
